(19) United States
(12) Patent Application Publication
(10) Pub. No.: US 2012/0194931 A1
(43) Pub. Date: Aug. 2, 2012

(54) M.R. Mirror Master-Left and Right Sides

(76) Inventors: Erick Morales, Chicago, IL (US); Valentin Rivera, Chicago, IL (US)

(21) Appl. No.: 13/361,338

(22) Filed: Jan. 30, 2012

Related U.S. Application Data
(60) Provisional application No. 61/462,115, filed on Jan. 28, 2011.

(51) Int. Cl. G02B 5/08

(52) U.S. Cl. 359/850

(57) ABSTRACT

The present invention provides a side mirror system to offer drivers an unfettered view of their surroundings when blind side backing and parking. The M.R. Mirror Master comprises a shatterproof plastic or metal casing and is mounted to the driver and passenger side panel of the truck by means of two, heavy duty horizontal support arms positioned at the top and bottom of the mirror. The upper mirror is approximately twice as tall as the lower adjacent mirror. Perpendicularly attached to and running horizontally from the center to the base of the mirror casing is a third fully adjustable hinged mirror. This mirror is designed to provide a clear view around the truck's trailer when engaged in blind side parking.

### CLAIM OF PRIORITY

This patent application claims priority under 35 USC 119 (e) (1) from U.S. Provisional patent application Ser. No. 61/462,115 filed Jan. 28, 2011, of Valentin Rivera and Erick Morales entitled, “M.R. Mirror Master-Left and Right Sides.”

### FIELD OF THE INVENTION

The present invention pertains to the field of truck and trailer accessories, and more specifically to the field of side mirrors for semi trucks and tractor trailers.

### BACKGROUND OF THE INVENTION

The prior art has put forth several designs of side mirrors for vehicles. Among these are:

U.S. Pat. No. 6,270,225 to Roger J. Goolsby describes blind spot side view mirrors containing three mirrored sections within each left and right side view mirror. The three areas reflected in these mirrors are the regular view area, the overtaking area, and the blind spot area.

U.S. Pat. No. 5,245,479 to Kenneth B. Falanga describes a vehicular side and rear view prismatic mirror system configured to be adhesively attached to the standard automotive side mirror and rear view mirror. The prism's positioning, size and angle of refraction can be configured in varying degrees to provide the user with the maximum efficient viewing of the blind spot.

U.S. Pat. No. 4,306,770 to Friedrich Marhauer describes a side mirror for vehicles containing a large and small mirror angled at each other wherein the large mirror is normal viewing and the smaller window encompasses a view of the blind spot.

None of these prior art references describe the present invention.

### SUMMARY OF THE INVENTION

It is an object of the present invention to provide semi trucks and tractor trailers with improved side mirrors for driving in traffic, backing up and parking the vehicle safely.

### BRIEF DESCRIPTION OF THE DRAWINGS

FIG. 1 shows a rear perspective view of a mirror of the present invention attached to the passenger side of a truck and oriented in a vertical position.

FIG. 2 shows a rear perspective view of the same mirror shown in FIG. 1 attached to the passenger side of the truck and extended in a horizontal position for blind side backing and parking.

FIG. 3 shows a rear perspective view of two mirrors attached to the passenger side of a truck and split in vertical and horizontal positions for blind side backing and parking.

FIG. 4 shows a rear perspective view of the same two mirrors shown in FIG. 3 attached to the passenger side of a truck and moved back into a vertical position for regular viewing while driving on the highway.

FIG. 5 shows a perspective view of the mirror control switch.

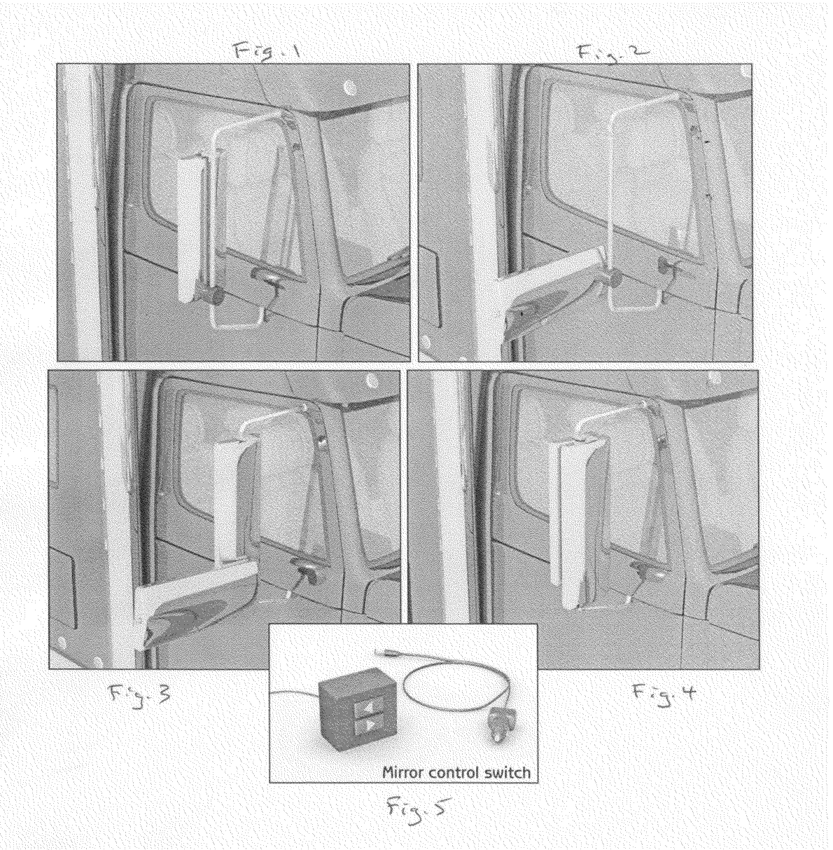

### DETAILED DESCRIPTION OF THE INVENTION

Millions of professional truckers head off across the highways, transporting goods and products to the consumer populace. It may be a local produce man delivering fresh milk and eggs to the neighborhood grocer, a commercial mover transporting a family's belongings across the state, or a long haul driver delivering medical supplies to hospitals across the country. Professional truck drivers are crucial members of society, delivering food, goods and supplies needed by people from all walks of life. The operators of delivery and transport rigs are required to abide the rules of the road, follow speed limits, yield the right of way and obey traffic signs and lights. One difficult task for a truck driver pertains to blind side backing and parking. Blind side backing typically involves backing a truck into a dock or parking spot. When engaged in a left side backing maneuver, a truck driver looks out the left side window to back into the designated space. In the case of right side or blind side backing, backing into a dock or parking space is more difficult because the view provided provided by the truck's right side mirror becomes blocked by the angled trailer. The driver cannot utilize the right side mirror to determine their position or the position of surrounding objects. The driver must then repeatedly stop the truck, jump out of the cab and visually check their location to ensure the truck is being properly and safely backed into the dock or parking space. Repeatedly jumping out of a truck in to visually check the positioning of the truck's trailer can be a time consuming and exhausting endeavor.

The present invention, hereinafter referred to as the M.R. Mirror Master, is a specially designed side mirror configured expressly to offer drivers an unfettered view of their surroundings when blind side backing and parking. Similar in general structure and appearance to a traditional trucking side mirror, the M.R. Mirror Master comprises a shatterproof plastic or metal casing and is mounted to the driver and passenger side panel of the truck by means of two, heavy duty horizontal support arms positioned at the top and bottom of the mirror. Rectangular in shape, the M.R. Mirror Master measures approximately nine inches in width by twenty-two inches in total height. The M.R. Mirror Master contains two independently operated mirrors with one positioned atop the other. The upper mirror is approximately twice as tall as the lower adjacent mirror. Both mirrors are mounted on separate moveable hinged platforms which enable the driver to control the positioning of the mirrors from inside the truck. The novel feature of the present invention resides in the third fully adjustable mirror perpendicularly attached to and running horizontally from the center to the base of the mirror casing. This third mirror can be positioned in a vertical configuration along side or behind the standard side mirror when not in use, and can be deployed to its horizontal position extending outward from the base of the standard side mirror when needed. Deployment of the third mirror can be effected by use of an in-cab remote switch which operates to control the extent and tilt of the mirror in a similar manner to remote control of side view mirrors. The third mirror measures approximately eleven inches in height and eighteen inches in length, this mirror is designed to provide a clear view around the truck's trailer when engaged in blind side parking. As with the base mirror, this extended mirror can be hinge mounted, affording the driver the ability to easily manipulate the positioning of the mirror for a clear view of the dock or parking area. The M.R. Mirror Master can be both electrically and manually powered, enabling the user to safely utilize the device in the event of an electrical breakdown of the vehicle. Professional drivers can have this device permanently installed in place of existing side mirrors. During regular vehicle operation, the M.R. Mirror Master serves as a traditional side mirror, providing a clear view of the road on either side of the truck. When blind side backing, the driver simply adjusts the positioning of the M.R. Mirror Master's vertical and horizontal mirrors, angling the main upper and lower mirror. The driver also can extend the horizontal mirror as necessary for a clear view around the trailer. With the extended and adjustable horizontal mirror, the driver sees several additional inches of viewing area. The driver now can back the truck into a dock or parking spot without having to manually climb out of the truck to check the positioning of the trailer. Using this invention eliminates the need to repeatedly stop one's vehicle, climb out of the truck cab and check the positioning of the vehicle from the ground. Sparing the truck driver this time consuming, tedious and exhausting task, the M.R. Mirror Master makes the necessary task of parking a truck significantly easier to execute. Ideal for installation on virtually any size truck, the M.R. Mirror Master can see around trailers ranging in length from approximately twenty-six feet to fifty-three feet. Durable and made with high quality materials, the M.R. Mirror Master will hold up through years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A side mirror system installed on trucks and trailers to facilitate blind side backing and parking, comprising a shatterproof plastic or metal casing mounted to the side of a truck by means of two heavy duty horizontal support arms positioned at the top and bottom of the mirror, and wherein the mirror comprises two independently operated mirrors with the first mirror positioned above the lower mirror, and wherein the upper mirror is approximately twice as tall as the lower mirror, and further wherein a third fully adjustable mirror is positioned perpendicular to and horizontal from the center of the upper mirror to the base of the mirror casing.

2. The mirror system of claim 1 wherein the upper mirror measures approximately eleven inches in height and eighteen inches in length, this mirror is designed to provide a clear view around the truck's trailer when engaged in blind side parking.

3. The mirror system of claim 1, wherein the third extended mirror is hinge mounted.

4. The mirror system of claim 3 wherein the third extended mirror is manually controlled.

5. The mirror system of claim 3 wherein the third extended mirror is electrically controlled.

6. The mirror system of claim 1, wherein the third mirror perpendicularly attached to and running horizontally from the center to the base of the mirror casing can be positioned in a vertical configuration along side or behind the vertical side mirror when not in use, and can be deployed to its horizontal position extending outward from the base of the vertical side mirror when needed.

7. The mirror system of claim 1 wherein the third mirror measures approximately nine inches in width.
